(19) United States
(12) Patent Application Publication
(10) Pub. No.: US 2007/0205250 A1
(43) Pub. Date: Sep. 6, 2007

(54) Printed circuit board apparatus and method for assembly

(76) Inventor: Ronald J. Dittmer, Dundee, IL (US)

Correspondence Address: MOTOROLA, INC., 1303 EAST ALGONQUIN ROAD, IL01/3RD, SCHAUMBURG, IL, 60196, US

(21) Appl. No.: 11/365,091

(22) Filed: Mar. 1, 2006

(51) Int. Cl. A47J 36/02

(52) U.S. Cl. 228/101

(57) ABSTRACT

A surface mounting assembly (SMA) process for manufacturing a printed circuit board (PCB), with the SMA process including the steps of: providing a circuit board with a plurality of metallic pads; depositing solder paste on at least a portion of the plurality of metallic pads; and mounting at least one electrical component having a metallic portion and a non-metallic portion onto the circuit board with at least some of the non-metallic portion contacting the solder paste.

### FIELD OF THE INVENTION

The present invention relates generally to printed circuit boards and more specifically to securing components in place while mounting them on a printed circuit board during a surface mount assembly process.

### BACKGROUND OF THE INVENTION

During a prior art surface mount assembly (SMA) process by which electrical components are mounted onto a printed circuit board (PCB), depending on the orientation of the components during the SMA process some of the electrical components can lack an adequate “anchoring footprint” to maintain the position of the electrical component throughout the duration of the SMA process. What is meant by the anchoring footprint is the surface area on the electrical component that is used as an anchor to hold the component in place during the SMA process.

FIG. 1 illustrates PCB apparatus 100 manufactured using a prior art SMA process. Apparatus 100 includes a PCB 102 having mounted thereon electrical components 104, 112, 116 and 118. Due to the configuration of the PCB, components 112, 116 and 118 were mounted in an orientation that is inverted with respect to the orientation in which they are normally mounted.

More specifically (and by reference to component 112), each component includes a non-metallic portion (e.g., 130) and metallic portions 126 (also referred to herein as solder joints) and 128 (also referred to herein as a solder plate). A metallic portion is defined herein as a portion that is solderable, substantially comprises a metal or metal composite material and that therefore has characteristics of a metal, and a non-metallic portion is a portion that is not solderable, substantially comprises non-metal material and that therefore lacks the characteristics of a metal. Typically, the electrical component is mounted on the PCB with the solder plate 128 on a corresponding solder pad included onto the circuit board 102 and with plate 128 contacting solder or solder paste that was deposited on the corresponding PCB solder pad during a previous step of the SMA process. Moreover, solder joints 126 are similarly mounted on corresponding solder pads included onto the circuit board 102, with solder joints 126 contacting solder or solder paste that was deposited on the corresponding PCB solder pads during a previous step of the SMA process. In this typical component orientation, both solder plate 128 and solder joints 126 function as the anchoring footprint for the electrical component and generally provide sufficient stability to keep the component in place as the PCB moves and vibrates during the SMA process.

However, in an inverted component orientation (as is illustrated by the orientation of components 112, 116 and 118 of FIG. 1), the non-metallic portion is over an area on the PCB 102 that has no solder pad included thereon, and solder joints 126 (being mounted as in the typical component orientation) solely provide for the anchoring footprint for the component. Accordingly, the anchoring footprint in this inverted component orientation is in many instances inadequate to restrain the movement of the component within necessary parameters that would enable a proper functioning of the electrical components if the populated PCB were used in an electronic device. The result is that the PCB apparatus would be rejected and would require further manual labor to adjust the components to a proper position, thereby increasing the manufacturing cost associated with the PCB apparatus. FIG. 1 further illustrates the results of electrical components 112 and 116 being jolted out of position during the SMA process, wherein the metallic portion 128 of component 112 is touching an electrical trace 120 at a point 122 (which could create an electrical short) and the metallic portions 128 of components 112 and 116 are also in contact with each other at a point 124 (which could cause one or both of those components to be in a raised position that may interfere with the housing (not shown) of the PCB apparatus 100). A further problem that may result from the prior art SMA processes (that is not illustrated in FIG. 1) is the solder joints (e.g., 126) being misaligned with their corresponding solder pads on the PCB, thereby adversely affecting electrical connections for the component.

A known solution for addressing the above-described shortcomings of the prior art SMA processes is the use of a specially designed fixture to mechanically hold the components in place during the SMA process. However, this solution is costly due to the added cost of the fixtures.

Thus, there exists a need to address the shortcomings in surface mount technology (SMT) by providing for a more cost efficient method to secure components in place while mounting them on a printed circuit board during a surface mount assembly process.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates PCB apparatus assembled using a prior art surface mount assembly process.

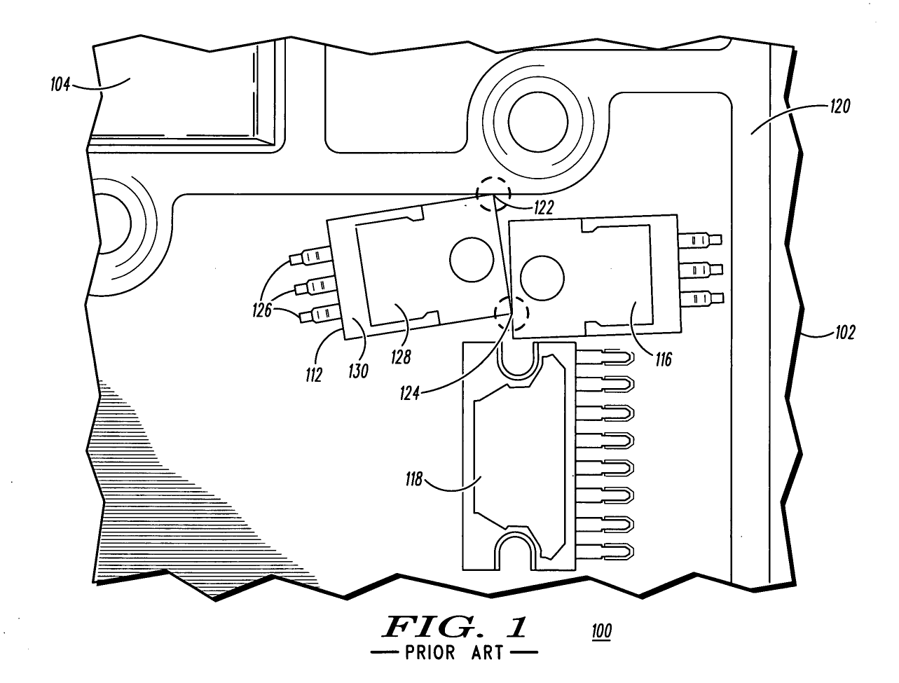

FIG. 2 illustrates a flow diagram of a surface mount assembly process in accordance with an embodiment of the present invention.

FIG. 3 illustrates an unpopulated PCB in accordance with an embodiment of the present invention.

FIG. 4 illustrates a PCB populated with electrical components using the surface mount assembly process illustrated in FIG. 2.

### DETAILED DESCRIPTION OF THE INVENTION

Before describing in detail embodiments that are in accordance with the present invention, it should be observed that the embodiments reside primarily in combinations of method steps and apparatus components related to a method and apparatus for populating a PCB with electrical components during a SMA process. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

Generally speaking, pursuant to the various embodiments, PCB apparatus is assembled in accordance with various embodiments of the present invention. A PCB is provided that comprises a plurality of solder pads included thereon, with some of the solder pads being located in predetermined and electrically isolated areas on the PCB such that a non-metallic portion of an electrical component can be mounted over the solder pad. Solder paste is deposited on some or all of the solder pads. At least one electrical component comprising a metallic portion and a non-metallic portion is mounted thereon with at least some of the non-metallic portion contacting the solder paste.

This SMA process provides for an improved anchoring footprint for electrical components over prior art SMA processes (especially for components mounted in an inverted orientation), wherein the improved anchoring footprint provides additional stability to restrain the movement of the component within a desired position throughout the SMA process. Moreover, the SMA process in accordance with the teachings herein is more cost efficient in that it does not require additional costly mechanical fixtures, and it decreases and ideally eliminates the number of PCB apparatus that require manual adjustments at the conclusion of the SMA process. Those skilled in the art will realize that the above recognized advantages and other advantages described herein are merely exemplary and are not meant to be a complete rendering of all of the advantages of the various embodiments of the present invention.

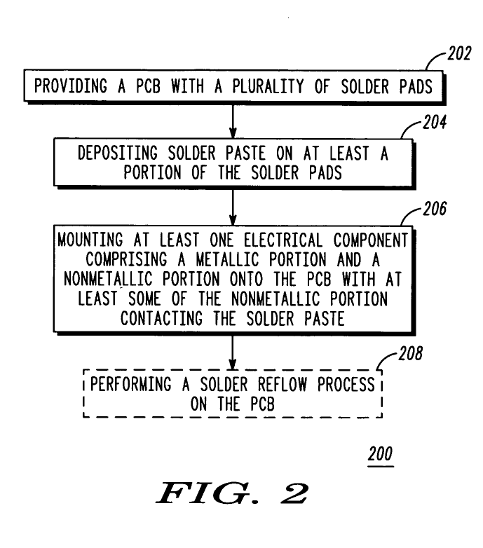

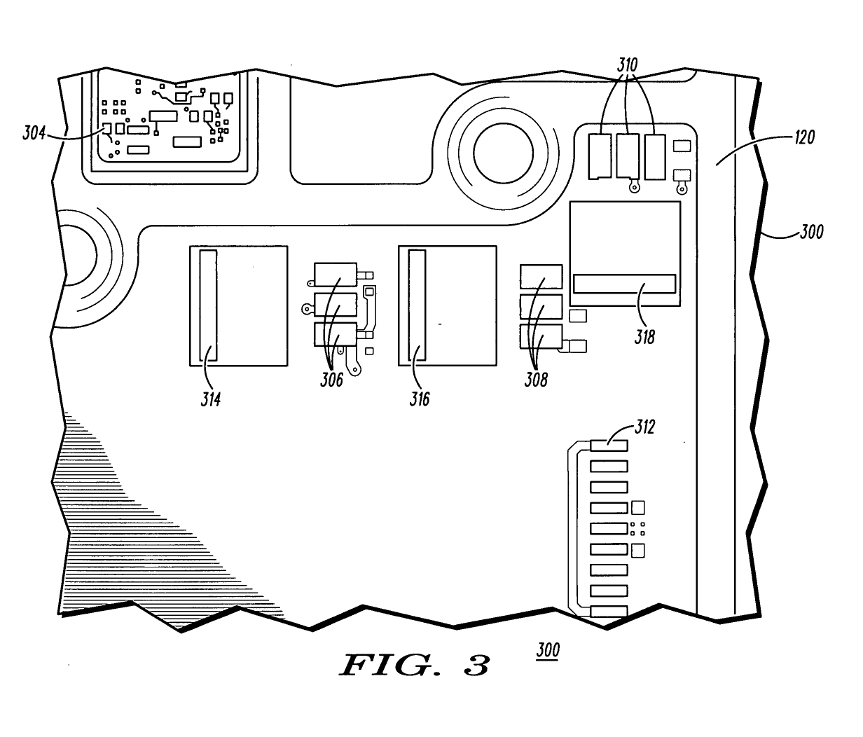

Referring now to the drawings, and in particular FIG. 2, a SMA process in accordance with an embodiment of the present invention is shown and indicated generally at 200. At a step 202, A PCB is provided that comprises a plurality of solder pads included thereon, with some of the solder pads being located in predetermined and electrically isolated areas on the PCB such that a non-metallic portion of an electrical component can be mounted over the solder pad. Turning momentarily to FIG. 3, illustrated therein is a portion 300 of a PCB board that may be provided for at step 202. Included on the PCB are a plurality of solder pads 304, 306, 308, 310, 312 314, 316 and 318. Some of the solder pads (e.g., 304, 306, 308, 310 and 312) are used in a conventional way, wherein solder or solder paste is deposited thereon so that a solder joint or other metallic portion of an electrical component can be attached to the solder pad during a solder reflow process. In addition and in accordance with the teachings herein, some of the solder pads (e.g., 314, 316 and 318) are used as described below for securing an electrical component in place during the SMA process by including a non-metallic portion of the component in the component's anchoring footprint.

Any suitable process may be used for creating a PCB as illustrated in FIG. 3, and those of ordinary skill in the art will recognize and appreciate that the specifics of the PCB manufacturing process are not specifics of the invention itself. In general, many PCB manufactures follow industry standard processes and use consistent material, wherein the creation of circuit patterns (e.g., electrical traces and solder pads) may be accomplished using both additive and subtractive methods (such as etching). The conductive circuit that electrically connects components mounted on the PCB is generally copper, although solder-plated copper, gold, and other metals are sometimes used. A printed circuit board may be single-sided, double-sided, and multi-layered, and the spatial and density requirement and the circuitry complexity determine the type of board produced. Moreover, a printed circuit board (or PCB) as used herein encompasses various electronic packaging techniques including, but not limited to, fiberglass and epoxy based materials (e.g., FR4), polyimide (also referred to in the art as “flex”technology), thick film, thin film, and other packaging technologies known or developed in the future. Since manufacturing processes for PCBs are well known in the art, additional information is not included herein for the sake of brevity.

At a step 204 solder paste is deposited on some or all of the solder pads. Currently, many SMT manufacturers are using substantially no-lead or substantially lead-free solder paste since this type of solder paste has been linked to being more environmentally friendly. Thus, lead-free solder paste may be used in step 204, but the teachings herein are not limited to the use of lead-free solder paste. Any type of solder paste may be used so long as it has sticky, tacky or adhesive properties that can be used in the inventive SMA process as described below in more detail.

As with the PCB manufacturing process any process for adding solder paste may be used, and those of ordinary skill in the art will recognize and appreciate that the specifics of the solder paste depositing process are not specifics of the invention itself. For example, solder paste printing processes (e.g., screen, stencil and dispensing) may be used whereby a solder paste printing machine applies solder paste to the solder pads in a controlled manner, including applying solder paste to those solder pads included on the circuit board in accordance with the teachings herein, such pads located under the non-metallic portion of certain of the electrical components mounted on the PCB. When applying solder paste to the solder pads, including those solder pads included on the circuit board in accordance with the teachings herein that will be located under the non-metallic portion of certain of the electrical components mounted on the PCB, care should be taken not to generate defects such as bridges, gaps, excess paste, poor print definition, and poor alignment, which may cause electrical shorts or interfere with desired electrical connections.

Turning back to process 200, at a step 206 at least one (and usually a plurality of) electrical component having a non-metallic portion and metallic portion is mounted onto the PCB with at least some of the non-metallic portion contacting the solder paste on one of the carefully placed solder pads. In one embodiment, such mounting is a result of the electrical component being mounted in an inverted component orientation as described above. However, those skilled in the art will realize that components may be designed having non-metallic portions in strategic and predetermined areas on the component to facilitate advantages of the teachings herein, such as an expanded anchoring footprint for an electrical component above what is available in known SMA processes. The components may comprise any type of component that could benefit from an increased anchoring footprint such as, for example, power transistors, capacitors, integrated circuits, etc.

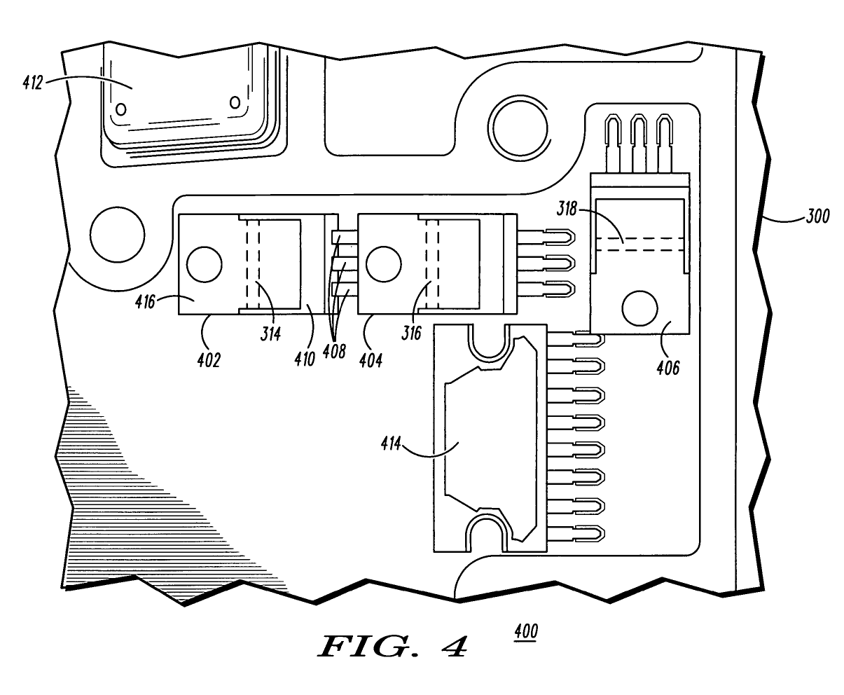

Turning to FIG. 4 momentarily, PCB apparatus 400 is shown, which includes PCB 300 having components 402, 404, 406, 412 and 414 mounted thereon. Components 412 and 416 are mounted in a traditional manner, with component 414 being mounted in an inverted component orientation. Components 402, 404 and 406 are mounted in an inverted component orientation in accordance with the teachings herein. More specifically and by reference to component 402, the electrical component comprises a non-metallic portion 410 that may be any suitable plastic for example and metallic portions 408 (solder joints) and 416 (a solder plate) that may comprise any suitable metal or metal composite. The non-metallic portion 410 is mounted over solder pad 314 (shown as dashed lines indicating that the pad is beneath the component) such that some of the non-metallic portion contacts the solder paste that was previously deposited thereon, thus increasing the anchoring footprint of the component to include not only the solder joints 408 but also an area of the non-metallic portion 410. During the remainder of the SMA process, the sticky or tacky properties of the solder paste function to hold component 402 in place, thereby restraining the component to a desired position. Electrical components 404 and 406 are similarly mounted with their respective non-metallic portions contacting solder paste on corresponding solder pads, respectively, 316 and 318 (also shown as dashed lines).

As can be seen in FIG. 4, the entire area of the non-metallic portion of the electrical component need not contact the solder paste. The amount of area of the non-metallic portion used for adequately anchoring an electrical component depends on a number of factors including, but not limited to, the size of the electrical component, the distance of the component from other components and/or electrical circuits on the PCB, the distance of the solder pad (e.g., 314, 316, 318) from metallic portions (such as solder joints) of the same component, the reflow properties of the solder paste used, etc. In the component orientation of component 402, the solder pad 314 is located in an area on the PCB board and underneath an area of non-metallic portion 410 that is substantially opposite the solder joints 408 of component 402. This placement of the solder pad 314 decreases and ideally eliminates the likelihood that solder from the solder pad 314 will create a bridge to solder joints 408, thereby creating a short in the electronic component 402 at the junction of the bridge. Moreover, although a single solder pad (e.g., 314, 316, 318) is illustrated in FIG. 4 as being located beneath the non-metallic portion of a corresponding electrical component, one or more such solder pads could be located under the component without departing from the scope of the teachings herein.

Returning again to SMA process 200, at a step 208 a solder reflow process is performed. Any solder reflow process may be used, and those of ordinary skill in the art will recognize and appreciate that the specifics of the solder reflow process are not specifics of the invention itself. Since such processes are well known in the art, the details are not included herein for the sake of brevity. Suffice to say that a further advantage of the teachings herein is that during the solder reflow process the solder paste on solder pads such as 314, 316 and 318 solidifies on the solder pad without affecting the functioning of the components on the PCB. Also, since the solder paste does not typically adhere to the non-metallic portion of the component once the paste solidifies, no additional stress is added to the part that would cause additional wear and tear on the part.

A PCB populated in accordance with embodiments of the present invention may be used in any number of electronic devices including, but not limited to, base radios, mobile and portable radios, televisions, etc.

In the above-described manner, an SMA process in accordance with the teachings herein provides for an improved anchoring footprint for electrical components over prior art SMA processes (for instance for components mounted in an inverted orientation), wherein the improved anchoring footprint provides additional stability to restrain the movement of the component within a desired position throughout the SMA process. Moreover, the SMA process in accordance with the teachings herein is more cost efficient in that it does not require additional costly mechanical fixtures, and it decreases and ideally eliminates the number of PCB apparatus that require manual adjustments at the conclusion of the SMA process.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A surface mounting assembly (SMA) process comprising the steps of:
providing a circuit board with a plurality of solder pads;
depositing solder paste on at least a portion of the plurality of solder pads; and
mounting at least one electrical component comprising a metallic portion and a non-metallic portion onto the circuit board with at least some of the non-metallic portion contacting the solder paste.

2. The SMA process of claim 1, further comprising the step of performing a solder reflow process on the circuit board with the at least one electrical component mounted thereon.

3. The SMA process of claim 1, wherein the step of adding solder paste comprises adding a substantially lead-free solder paste.

4. The SMA process of claim 1, wherein the step of mounting at least one component comprises mounting the at least one component in an inverted orientation.

5. Apparatus comprising:
a circuit board with a plurality of solder pads; and
at least one electrical component comprising a metallic portion and a non-metallic portion mounted onto the circuit board with the non-metallic portion positioned over at least one of the solder pads.

6. The apparatus of claim 5, wherein the metallic pad positioned under the non-metallic portion received solder paste that came into contact with the non-metallic portion during a surface mount assembly process.

7. The apparatus of claim 6, wherein the solder paste is a substantially lead-free solder paste.

8. The apparatus of claim 5, wherein the apparatus is included in a mobile radio.

9. The apparatus of claim 5, where the solder pads comprise at least one of copper, solder-plated copper and gold.

10. The apparatus of claim 5, wherein the circuit board is manufactured using one of fiberglass and epoxy based materials, polyimide, thick film and thin film electronic packaging technology.
